(19) United States
(12) Patent Application Publication
(10) Pub. No.: US 2025/0116375 A1
(43) Pub. Date: Apr. 10, 2025

(54) SYSTEM AND METHOD FOR OPTIMIZED WITHDRAWAL OF FLUID FROM STORAGE TANKS FOR LONG TERM STORAGE IN A SUBTERRANEAN VOID

(71) Applicant: HORISONT ENERGI AS, Sandnes (NO)

(72) Inventor: Bjørgulf HAUKELIDSÆTER EIDESEN, Stavanger (NO)

(21) Appl. No.: 18/729,221

(22) PCT Filed: Jan. 12, 2023
(86) PCT No.: PCT/EP2023/050598

§ 371 Date: Jul. 16, 2024

(30) Foreign Application Priority Data
Jan. 18, 2022 (EP) 22152068.7

(51) Int. Cl. F17C 7/00; E21B 41/00

(52) U.S. Cl. CPC F17C 7/00; E21B 41/0064; F17C 2227/0302

(57) ABSTRACT

There is provided a fluid withdrawal system in a fluid handling system for handling fluid to be injected into a subterranean reservoir at an offshore injection site for long term storage, the fluid handling withdrawal system comprising a fluid storage with a fluid outlet and an injection pump connectable to at least one injection riser such that fluid is enabled to flow from the injection pump to the subterranean reservoir. The system further comprises a set of fluid holding elements comprising at least one of the fluid storage and the first fluid conduit and being configured to be in thermal contact with a heat source. There is also provided a corresponding method and non-transitory computer-readable storage medium.

### TECHNICAL FIELD

The present invention relates generally to strategies for reducing the amount of environmentally unfriendly gaseous components in the atmosphere. Especially, the invention relates to withdrawal of fluid for long term storage in a subterranean void from storage tanks in an optimized manner, while decreasing or minimizing the cost for transporting the CO₂ to the storage site.

### BACKGROUND

Carbon dioxide is an important heat-trapping gas, a so-called greenhouse gas, which is released through certain human activities such as deforestation and burning fossil fuels. However, also natural processes, such as respiration and volcanic eruptions generate carbon dioxide.

Today's rapidly increasing concentration of carbon dioxide, CO₂, in the Earth's atmosphere is problem that cannot be ignored. Over the last 20 years, the average concentration of carbon dioxide in the atmosphere has increased by 11 percent; and since the beginning of the Industrial Age, the increase is 47 percent. This is more than what had happened naturally over a 20000 year period-from the Last Glacial Maximum to 1850.

Various technologies exist to reduce the amount of carbon dioxide produced by human activities, such as renewable energy production. There are also technical solutions for capturing carbon dioxide from the atmosphere and storing it on a long term/permanent basis in subterranean reservoirs.

For practical reasons, most of these reservoirs are located under mainland areas, for example in the U.S.A and in Algeria, where the In Salah CCS (carbon dioxide capture and storage system) was located. However, there are also a few examples of offshore injection sites, represented by the Sleipner and Snøhvit sites in the North Sea. At the Sleipner site, CO₂ is injected from a bottom fixed platform. At the Snøhvit site, CO₂ from LNG (Liquefied natural gas) production is transported through a 153 km long 8 inch pipeline on the seabed and is injected from a subsea template into the subsurface below a water bearing reservoir zone as described inter alia in Shi, J-Q, et al., “Snøhvit CO₂ storage project: Assessment of CO₂ injection performance through history matching of the injection well pressure over a 32-months period”, Energy Procedia 37 (2013) 3267-3274. The article, Eiken, O., et al., “Lessons Learned from 14 years of CCS Operations: Sleipner, In Salah and Snøhvit”, Energy Procedia 4 (2011) 5541-5548 gives an overview of the experience gained from three CO₂ injection sites: Sleipner (14 years of injection), In Salah (6 years of injection) and Snøhvit (2 years of injection).

The related art document KR20180062039A discloses a carbon dioxide injection and treatment system into the ocean sediment layer. Other related art documents include KR20200112522A that discloses a carbon dioxide underground storage system, JP2003001101A that discloses equipment for feeding liquid carbon dioxide into deep ocean water, and KR101399442B1 that discloses an apparatus for liquefaction and underground injection of carbon dioxide.

However, injection of CO₂ as disclosed by the related art documents generally suffers from drawbacks related to the process of transporting and injecting the CO₂ into the storage sites. Both in terms of the time required for transporting the CO₂ in a transport vessel and in terms of the energy required to operate the vessel and to withdraw the CO₂ from temporary storage in order to be able to inject it into the injection site, there are significant problems with the known solutions. As a result, the cost of transport is rendered excessively high. This problem is generally not known or discussed in the related art documents.

Thus, solutions are known for storing CO₂ in general. However, there exists a need for an improved solution for decreasing or minimizing the cost for transporting the CO₂ to the storage site.

### SUMMARY

The overall aim of the present invention is to optimize energy over time spent retrieving, or withdrawing, fluid from storages, i.e. minimizing the amount of energy that needs to be generated to keep the pressure and temperature in the systems parts maintained/regulated, while at the same time minimizing the withdrawal time.

This is achieved by adding energy in the form of passive heating and heating retrieved from other heating sources such as vessel engine waste heat, onshore preheating of fluid, waste heat from a compressor that is optionally included in the system, etc., providing enhanced convection of heat from the environment.

Specifically, the fluid injection rate as well as the temperature and pressure regulation in pipe elements of the system are controlled using model predictive control (MPC) regulation, where an objective function is minimized, which objective function preferably weighs in the withdrawal rate, the overall time to empty the storage and the total energy consumption.

Recompression of gas form fluid is also used for further controlling the pressure.

According to one aspect of the invention, the object is achieved by a system for handling, specifically withdrawing from storage, fluid to be injected into a subterranean reservoir, or subterranean void, at an offshore injection site, for long term storage.

The fluid withdrawal system comprises a fluid storage for storing fluid to be injected, the fluid storage comprising a fluid outlet; and the fluid withdrawal system also comprises an injection pump operatively connected to the fluid storage outlet via a first fluid conduit for withdrawing fluid from the fluid storage, wherein the injection pump is connectable to at least one injection riser, such that fluid is enabled to flow from the injection pump to the subterranean reservoir when connected to the at least one injection riser. Also, the fluid withdrawal system comprises a set of fluid holding elements comprising at least one of the fluid storage, and the first fluid conduit is configured to be in thermal contact with a heat source such that thermal energy can be transferred from the heat source to the fluid comprised in the fluid storage and/or the first fluid conduit.

A main advantage of the fluid withdrawal system according to the present invention is that by the arrangement that the first fluid conduit is configured to be in thermal contact with the heat source such that thermal energy can be transferred from the heat source to the fluid comprised in the fluid storage and/or the first fluid conduit, the withdrawal of CO₂ is achieved in a highly energy efficient way while also taking significantly less time than in the known prior art systems. This decreases the transport cost for transporting and injecting CO₂ so that the process as a whole is rendered more efficient and convenient. The shorter the time spent on the field injecting the CO₂, the higher the annual injected CO₂ volume. This, in turn, reduces the cost of CO₂ injection per unit of CO₂. However, there is a tradeoff between cost of energy and the withdrawal rate. Namely, the energy cost needs to be lower than reduction in CO₂ unit cost per injected unit of CO₂.

The fluid withdrawal system also comprises a compressor arranged to compress gas phase fluid to liquid phase fluid, wherein the fluid storage further comprises a fluid storage intake, and wherein the compressor is operatively connected to the fluid storage intake via a second fluid conduit for recirculating liquid phase fluid from the compressor to the fluid storage. Also, the first fluid conduit diverges into a first part for transporting liquid fluid to the injection pump and a second part for transporting gas phase fluid, separated from the liquid fluid, to the compressor, such that part of the fluid flows in a loop from the fluid storage to the compressor and back to the fluid storage. Thereby, fluid that is extracted from the fluid storage in gas phase can be returned to liquid phase by the compressor and be reintroduced into the fluid storage. This is also highly advantageous, since it allows for separating the liquid phase fluid for injection while at the same time recirculating the gas phase fluid to be extracted again at a later time. By allowing the extracted fluid to be both in the liquid phase and in the gas phase, a wider range for the pressure and temperature can be allowed, thus also rendering the withdrawal system more energy efficient. In order to further increase energy efficiency, heat generated by the compressor may be used to increase the temperature of the fluid withdrawal system as desired.

Furthermore, the compressor, the first fluid conduit is configured to separate gas phase fluid from liquid phase fluid at the point where the first fluid conduit diverges into the first part and the second part by compact gravity based separation. This is beneficial in allowing the separation of gas from liquid to be highly energy efficient while still preventing the mixing of the gas and liquid after the separation has taken place.

The system further comprises a controller configured to control the pressure and temperature in each fluid holding element in the set of fluid holding elements such that the pressure is maintained, within a preset pressure tolerance, and the temperature is maintained, within a preset temperature tolerance, based on a thermodynamic model of the first fluid conduit, using model predictive control, MPC, regulation. The controller is further configured to control the operation of the injection pump based on a set fluid withdrawal rate.

The withdrawal of CO₂ is thereby achieved in an even more highly energy efficient way while also taking significantly less time than in the known prior art systems. This further decreases the transport cost for transporting and injecting CO₂ so that the process as a whole is rendered more efficient and convenient.

Moreover, the heat source comprises at least one of:
a first medium surrounding and being in thermal contact with the fluid storage and/or the first fluid conduit such that thermal energy can be transferred from the first medium to the fluid comprised in the fluid storage and/or the first fluid conduit; or
a second medium comprised in a conduit or container which is arranged in thermal contact with the fluid storage and/or the first fluid conduit such that thermal energy can be transferred from the second medium to the fluid comprised in the fluid storage and/or the first fluid conduit.

Thereby, thermal energy may be transferred to the fluid in a highly advantageous manner to maintain energy efficiency of the fluid withdrawal system. In some embodiments, the first medium may be air or another fluid such as an inert gas (e.g. N₂). In some embodiments, the second medium may also or alternatively be an inert gas (e.g. N₂) or another fluid.

The system is further configured to transfer thermal energy, via the first and second mediums in the form of heat from the ambient air, and/or waste heat from the engine of the vessel received via a conduit or other conveying device, and/or waste heat from the compressor received via a conduit or other conveying device if the compressor is comprised in the system.

According to embodiments of the invention, the set of fluid holding elements may further comprise one or more of the second fluid conduit, the first part of the first fluid conduit and the second part of the first fluid conduit. Thereby, these parts of the conduits may also be included in the MPC regulation according to the present invention.

Suitably, the fluid outlet is configured to be operable into the multiphase region and the first fluid conduit is configured to transport multiphase fluid from the fluid storage. Thereby, the pressure in the fluid storage may be decreased even further while still maintaining the injection at a desired rate.

Suitably, the heat source may be pre-heated. This further increases energy efficiency during use of the fluid withdrawal system. In some embodiments, the heat source is arranged to be preheated by ambient air or by waste heat from e.g. engines that is conveyed or otherwise made available to heat the heat source.

Also, the fluid withdrawal system may suitably comprise a heating device configured to increase a temperature of the heat source as it passes through the heating device before the heat source is brought into thermal contact with the set of fluid holding elements. This is also advantageous in providing an energy efficient fluid withdrawal system.

The heating device may suitably comprise at least one of a heat exchanger or a heat pump. This also renders the heating device energy efficient and allows the fluid extraction to take place in a desired way.

According to a second aspect of the invention, the object is achieved by a method for withdrawing, in a fluid withdrawal system, fluid to be injected into a subterranean reservoir, or subterranean void, at an offshore injection site from a fluid storage, for long term storage. The fluid withdrawal system comprises an injection pump operatively connected to an outlet of the fluid storage via a first fluid conduit for withdrawing fluid from the fluid storage, wherein the injection pump is connectable to at least one injection riser, such that fluid is enabled to flow from the injection pump to the subterranean reservoir when connected to the at least one injection riser, the fluid withdrawal system further comprising a set of fluid holding elements including at least one of the fluid storage and the first fluid conduit, wherein the method comprises arranging the set of fluid holding elements to be in thermal contact with a heat source such that thermal energy can be transferred from the heat source to the fluid comprised in the fluid storage and/or the first fluid conduit.

The first fluid conduit diverges into a first part for transporting liquid fluid to the injection pump and a second part for transporting gas phase fluid, and the method further comprises:
separating the fluid that has been withdrawn from the fluid storage into gas phase fluid and liquid phase fluid;
transporting the gas phase fluid via the second part of the first fluid conduit to a compressor for compressing gas phase fluid to liquid phase fluid;
compressing the gas phase fluid to liquid phase fluid, by the compressor; and
recirculating the liquid phase fluid from the compressor to an intake of the fluid storage via a second fluid conduit, such that part of the fluid flows in a loop from the fluid storage to the compressor and back to the fluid storage. Separating the fluid that has been withdrawn from the fluid storage into gas phase fluid and liquid phase fluid is effected by compact gravity based separation.

The method also comprises controlling, by a controller comprised in the fluid withdrawal system, the pressure and temperature in each fluid holding element in the set of fluid holding elements such that the pressure is maintained, within a preset pressure tolerance, and the temperature is maintained, within a preset temperature tolerance, based on a thermodynamic model of the first fluid conduit, using model predictive control, MPC, regulation. The method further comprises controlling, by the controller, the operation of the injection pump based on a set fluid withdrawal rate.

Additionally, the method further comprises operating the fluid outlet into the multiphase region.

The heat source comprises at least one of a first medium surrounding and being in thermal contact with the fluid storage and/or the first fluid conduit such that thermal energy can be transferred from the first medium to the fluid comprised in the fluid storage and/or the first fluid conduit; or a second medium comprised in a conduit or container which is arranged in thermal contact with the fluid storage and/or the first fluid conduit such that thermal energy can be transferred from the second medium to the fluid comprised in the fluid storage and/or the first fluid conduit; wherein controlling, by the controller, the pressure and temperature in each fluid holding element in the set of fluid holding elements comprises controlling the pressure and temperature using thermal heat transfer to or from the first or second medium.

Additionally, the method comprises transferring or conveying thermal energy via the first and second mediums in the form of heat from the ambient air, and/or waste heat from the engine of the vessel received via a conduit or other conveying device, and/or waste heat from the compressor received via a conduit or other conveying device if the compressor is comprised in the system.

The method may further comprise pre-heating the heat source. Alternatively, or additionally, the method may comprise increasing the temperature of the heat source using a heating device before the heat source is brought into thermal contact with the set of fluid holding elements.

According to a third aspect of the invention, the object is achieved by a non-transitory computer-readable storage medium storing instructions which, when executed by processing circuitry of the system, cause the system to perform the steps and functions of the method according to any of the appended method claims.

According to one or more embodiments in any aspect of the invention, the fluid may be, or comprise, carbon dioxide.

Further advantages, beneficial features and applications of the present invention will be apparent from the following description and the dependent claims. Any advantage described herein for the system embodiments is equally applicable to corresponding embodiments of any other aspect of the invention.

### BRIEF DESCRIPTION OF THE DRAWINGS

The invention is now to be explained more closely by means of preferred embodiments, which are disclosed as examples, and with reference to the attached drawings.

FIG. 1 schematically illustrates an arrangement for long term storage of fluids in a subterranean void in which a system according to embodiments of the invention is comprised;

FIG. 2 schematically illustrates a system according to one embodiment of the invention;

FIG. 3 schematically illustrates an arrangement in which a system according to one embodiment of the invention is comprised;

FIG. 4 schematically illustrates an arrangement in which a system according to one or more embodiment of the invention is comprised;

FIG. 5 is a flow diagram illustrating a method according to one embodiment of the invention; and

FIGS. 6 is a flow diagram illustrating additional method steps that may be included in the method in FIG. according to one embodiment of the invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

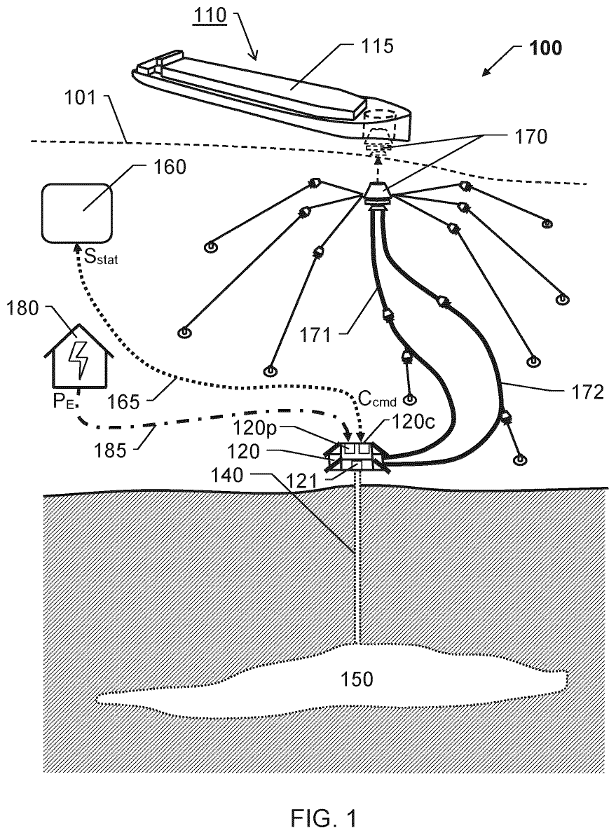

An arrangement for long term storage of fluids in a subterranean reservoir, or subterranean void, in which a system according to embodiments of the invention is comprised will first be described in connection with FIG. 1.

In the context of the present invention, long term storage may mean permanent storage, or it may mean storage for a very long, indefinite, amount of time.

Long term storage in a subterranean reservoir may be referred to as sequestration.

In FIG. 1, we see an arrangement for long term storage of fluids in a subterranean void, in which a system 200 according to embodiments of the invention is comprised.

The fluid may e.g. contain at least 60 wt. % carbon dioxide.

The subterranean void, or accommodation space, is typically a subterranean aquifer. However, according to the invention, the subterranean void 150 may equally well be a reservoir containing gas and/or oil, a depleted gas and/or oil reservoir, a carbon dioxide storage/disposal reservoir, or a combination thereof. These subterranean accommodation spaces are typically located in porous or fractured rock formations, which for example may be sandstones, carbonates, or fractured shales, igneous or metamorphic rocks.

The fluid storage may comprise one or more fluid tank of a surface vessel, wherein the subsea template is configured to receive fluid from the fluid storage via at least one injection riser. Alternatively, or additionally, the fluid storage may comprise an onshore fluid storage, wherein the subsea template is configured to receive fluid from the fluid storage via at least one fluid injection conduit, or wherein the fluid storage is a subsea CO₂ fluid storage, wherein the subsea template is configured to receive fluid from the fluid storage via at least one fluid injection conduit.

A subsea template 120 may be in fluid connection with two or more well heads for drill holes 140 to a subterranean void 150, or two or more well heads for drill holes 140 to more than one subterranean void 150 and may comprise a valve system 121 for controlling the injection of fluid into the subterranean void 150. The fluid connection between the subsea template 120 and the well heads may be enabled via separate conduits or a distribution manifold.

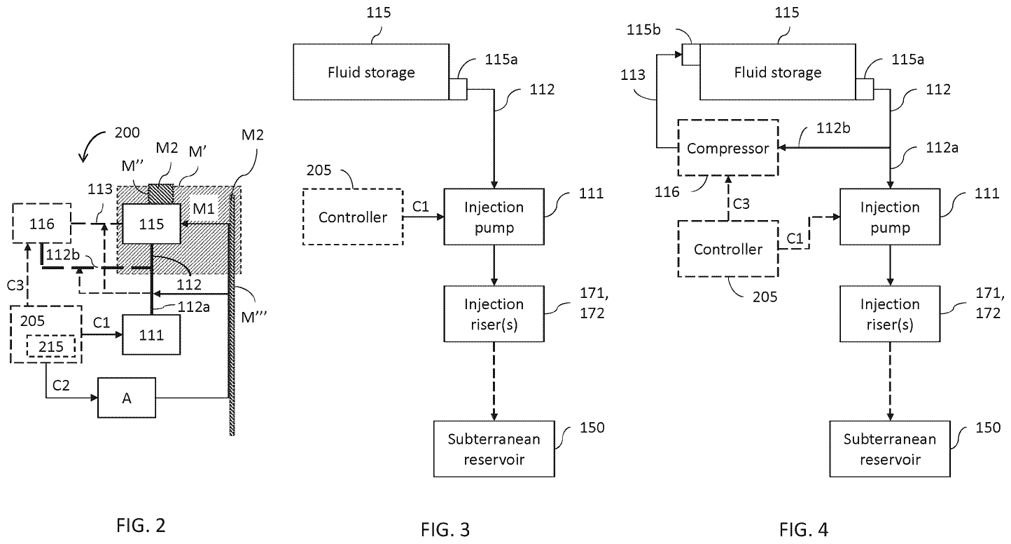

The system 200 may also comprise a control site 160 being communicatively connected to the other system components. The control site, generically identified as 160, may be positioned at a location geographically separated from the offshore injection site 100, for example in a control room onshore. However, additionally or alternatively, the control site 160 may be positioned at an offshore location geographically separated from the offshore injection site, for example at another offshore injection site. Consequently, a single control site 160 can control multiple off-shore injection sites 100. There is also large room for varying which control site 160 controls which offshore injection site 100. Communications and controls are thus located remote from the offshore injection site 100. Alternatively, or additionally, the control site 160 may located in the surface vessel, or be integrated in the subsea template in the form of a local processor. The offshore injection site 100 may be powered locally, remotely or both. The controller 205 described in connection with FIGS. 2, 3 and 4 may be comprised in the control site 160.

The offshore injection site 100 may include a buoy-based off-loading unit 170, for instance of submerged turret loading (STL) type. When inactive, the buoy-based off-loading unit 170 may be submerged to 30-50 meters depth, and when the vessel 110 approaches the offshore injection site 100 to offload fluid, the buoy-based off-loading unit 170 and at least one injection riser 171 and 172 connected thereto are elevated to the water surface 101. After that the vessel 110 has been positioned over the buoy-based off-loading unit 170, this unit is configured to be connected to the vessel 110 and receive the fluid from the vessel's fluid tank(s)/storage(s) 115, for example via a swivel assembly in the vessel 110.

Each of the at least one injection riser 171 and 172 respectively is configured to forward the fluid from the buoy-based off-loading unit 170 to the subsea template 120, which, in turn, is configured to pass the fluid on via the well head and the drill hole 140 down to the subterranean void 150.

The subsea template 120 may contain a power input interface 120p, which is implemented in at least one utility module and is configured to receive electric energy PE for operating the utility system. The power input interface 120p may be configured to receive the electric energy PE to be used in connection with operating a well at the well head.

FIG. 1 illustrates a generic power source 180, which is configured to supply the electric power PE to the power input interface 120p. It is generally advantageous if the electric power PE is supplied via a cable 185 from the power source 180 in the form of low-power direct current (DC) in the range of 200V-1000V, preferably around 400V. The power source 180 may either be co-located with the offshore injection site 100, for instance as a wind turbine, a solar panel and/or a wave energy converter; and/or be positioned at an onshore site and/or at another offshore site geographically separated from the offshore injection site 100. Thus, there is a good potential for flexibility and redundancy with respect to the energy supply for the offshore injection site 100.

In order to enable remote control from the control site 160, the subsea template 120 may contain a communication interface 120c that is communicatively connected to the control site 160. According to one embodiment of the invention, the communication interface 120c is implemented in the utility module. The communication interface 120c is also configured to receive the control commands C_{cmd} via the communication interface 120c, and optionally further to return status signals Sₛₜₐₜ to the control site 160. The status signals Sₛₜₐₜ may be indicative of a status of the system 200, for example, but not limited to, if there is a failure of any of the system components.

Depending on the channel(s) used for forwarding the control commands C_{cmd} between the control site 160 and the offshore injection site 100, the communication interface 120c may be configured to receive the control commands C_{cmd} via a submerged fiber-optic and/or copper cable 165, a terrestrial radio link (not shown) and/or a satellite link (not shown). In the latter two cases, the communication interface 120c includes at least one antenna arranged above the water surface 101.

Embodiments of a system according to the invention will now be described in connection with FIGS. 2, 3 and 4.

FIG. 2 schematically illustrates a system according to one embodiment of the invention.

FIG. 3 and FIG. 4 schematically illustrate an arrangement in which a system according to embodiments of the invention is comprised.

Turning first to FIGS. 2 and 3, there is shown a fluid withdrawal system 200 in a fluid handling system for handling fluid to be injected into a subterranean reservoir, or subterranean void, 150 at an offshore injection site 100, for long term storage. The fluid withdrawal system 200 comprises at least one fluid storage 115 for storing fluid to be injected into a long term subterranean reservoir 150, wherein each of the least one fluid storage 115 has a fluid outlet 115a. The fluid withdrawal system 200 further comprises an injection pump 111 operatively connected to the fluid storage outlet 115a via a first fluid conduit 112 for withdrawing fluid from the fluid storage 115. The injection pump 111 is connectable to at least one injection riser 171, 172, such that fluid is enabled to flow from the injection pump 111 to the subterranean reservoir 150 when connected to the at least one injection riser 171, 172. The fluid withdrawal system 200 comprises a set of fluid holding elements including at least one of the fluid storage 115 and the first fluid conduit 112. The set of fluid holding elements is configured to be in thermal contact with a heat source such that thermal energy can be transferred from the heat source to the fluid comprised in the fluid storage 115 and/or the first fluid conduit 112. Thereby, control of the pressure and temperature in the set of fluid holding elements is enabled.

Turning now to FIGS. 2 and 4, the fluid withdrawal system 200 may advantageously comprise a compressor 116 for compressing gas phase fluid to liquid phase fluid. In these embodiments, the fluid storage 115 further comprises a fluid storage intake 115b and the compressor 116 is operatively connected to the fluid storage intake 115b via a second fluid conduit 113 for recirculating liquid phase fluid from the compressor 116 to the fluid storage 115. The first fluid conduit 112 suitably diverges into a first part 112a for transporting liquid phase fluid to the injection pump 111 and a second part 112b for transporting gas phase fluid, separated from the liquid phase fluid, to the compressor 116, such that part of the fluid flows in a loop from the fluid storage 115 to the compressor 116 and back to the fluid storage 115.

In one or more embodiments, the fluid withdrawal system 200 comprises a controller 205 that is configured to control the operation of the injection pump 111 based on a set fluid withdrawal rate. To this end, the controller 205 may be configured to generate a first control signal C1 based on a desired withdrawal rate and/or injection rate, the first control signal C1 being configured to cause the injection pump 111 to operate at an effect such that the desired withdrawal rate is met in response to receiving the first control signal C1. The withdrawal rate may indicate the desired time for emptying the fluid storage or the desired effect at which the pump is to operate. In some embodiments, the withdrawal rate may be determined based on the desired injection rate for injection into the subterranean void 150, or vice versa, as these are to some extent co-dependent variables.

The controller 205 may additionally or alternatively be configured to control the pressure and temperature in each fluid holding element in the set of fluid holding elements such that the pressure is maintained, within a preset pressure tolerance, and the temperature is maintained, within a preset temperature tolerance, based on a thermodynamic model of the first fluid conduit 112, using model predictive control, MPC, regulation. As illustrated in

FIG. 2, the controller 205 may be configured to generate for each fluid holding element in the set of fluid holding elements a second control signal C2, based on a thermodynamic model of the fluid holding element, and using model predictive control, MPC, regulation. The second control signal is configured to cause at least one actuator A to add energy in the form of heat to the respective fluid holding element in response to receiving the second control signal C2 associated with that fluid holding element. The at least one actuator A that is controlled by the controller 205 may comprise any or all of exemplified heat supplying units, heating devices and substances/mediums described herein.

Thereby, by controlling the pressure and temperature during withdrawal, the withdrawal of CO₂ is achieved in a highly energy efficient way while also taking significantly less time than in the known prior art systems. This decreases the transport cost for transporting and injecting CO₂ so that the process as a whole is rendered more efficient and convenient.

As illustrated in FIG. 2, the controller 205 may be configured to generate a third control signal C3 configured to cause the compressor 116 to operate at an effect such that the gas phase fluid is compressed to liquid phase fluid and/or such that the compressor 116 recirculates compressed liquid phase fluid from the compressor 116 to the fluid storage 115 in response to receiving the third control signal C3. Thereby, fluid that is extracted from the fluid storage in gas phase can be returned to liquid phase by the compressor and be reintroduced into the fluid storage. This is also highly advantageous, since it allows for separating the liquid phase fluid for injection while at the same time recirculating the gas phase fluid to be extracted again at a later time. By allowing the extracted fluid to be both in the liquid phase and in the gas phase, a wider range for the pressure and temperature can be allowed, thus also rendering the withdrawal system more energy efficient. In order to further increase energy efficiency, heat generated by the compressor may be used to increase the temperature of the fluid withdrawal system as desired.

The first fluid conduit 112 may be configured to separate gas phase fluid from liquid phase fluid at the point where the first fluid conduit 112 diverges into the first part 112a and the second part 112b by automatic methods such as compact gravity based separation. This is beneficial in allowing the separation of gas from liquid to be highly energy efficient while still preventing the mixing of the gas and liquid after the separation has taken place.

Alternatively, or additionally, the compressor 116 may be configured to separate the fluid that has been withdrawn from the fluid storage into gas phase fluid and liquid phase fluid by actively drawing or retrieving gas phase fluid to enter the second part 112b of the first fluid conduit 112, using any suitable known technique, hence allowing only (or substantially only) liquid phase fluid to reach the injection pump 111 via the first part 112a of the first fluid conduit 112. Using active retrieval of the gas phase liquid, alone or in combination with compact gravity based separation, is beneficial as it provides an increased control of the separation and may render higher separation efficiency compared to using only compact gravity based separation.

In embodiments comprising the compressor 116, the set of fluid holding elements may further comprise at least one of the second fluid conduit 113, the first part 112a of the first fluid conduit 112 and the second part 112b of the first fluid conduit 112. Thereby, these parts of the conduits may also be included in the MPC regulation according to the present invention.

In embodiments comprising the compressor 116, the fluid outlet 115a may further be configured to be operable into the multiphase region wherein the first fluid conduit 112 is configured to transport multiphase fluid from the fluid storage 115. Thereby, the pressure in the fluid storage may be decreased even further while still maintaining the injection at a desired rate.

As schematically illustrated in FIG. 2, in some embodiments the heat source may comprise at least one of a first medium M1 or a second medium M2.

The first medium, M1, surrounds and is in thermal contact with the fluid storage and/or the first fluid conduit such that thermal energy can be transferred from the first medium, M1, to the fluid comprised in the fluid storage and/or the first fluid conduit. This is in FIG. 2 exemplified by the area M′ surrounding and being in thermal contact with the fluid storage 115 and at least part of the such that thermal energy can be first fluid conduit 112, transferred from the first medium, M1, to the fluid comprised in the fluid storage 115 and/or the first fluid conduit 112.

The second medium, M2, is comprised in a conduit or container which is arranged in thermal contact with the fluid storage 115 and/or the first fluid conduit such that thermal energy can be transferred from the second medium, M2, to the fluid comprised in the fluid storage 115 and/or the first fluid conduit 112. In FIG. 2, this is exemplified by a container M″ comprising the second medium M2 and being in thermal contact with the fluid storage 115, and a conduit M′' comprising the second medium M2 and being in thermal contact with the first fluid conduit 112.

In embodiments wherein the set of fluid holding elements comprises at least one of the second fluid conduit 113, the first part 112a of the first fluid conduit 112 and the second part 112b of the first fluid conduit 112, the first and second mediums M1, M2 may in the same manners be used to transfer thermal energy also to these fluid holding elements.

The system 200 may be configured to transfer thermal energy, via the first and second mediums M1, M2, in the form of heat from the ambient air, and/or waste heat from the engine of the vessel received via a conduit or other conveying device, and/or waste heat from the compressor 116 received via a conduit or other conveying device if the compressor 116 is comprised in the system 200.

The examples in FIG. 2 are for illustrational purposes only and any suitable combination and arrangement of the first medium M1 and/or at least one container comprising the second medium M2 and/or at least one conduit comprising the second medium M2 may be used to provide the desired thermal contact with the fluid storage 115 and/or the first fluid conduit 112 and/or the second fluid conduit 113.

Thereby, thermal energy may be transferred to the fluid in a highly advantageous manner to maintain energy efficiency of the fluid withdrawal system. In some embodiments, the first medium M1 may be air or another fluid such as an inert gas (e.g. N₂). In some embodiments, the second medium M2 may also or alternatively be an inert gas (e.g. N₂) or another fluid.

Suitably, the heat source may be pre-heated. This further increases energy efficiency during use of the fluid withdrawal system. In some embodiments, the heat source may be preheated by ambient air or by waste heat from e.g. engines that can be made available to heat the heat source.

Also, the fluid withdrawal system 200 may suitably comprise at least one heating device configured to increase a temperature of the heat source as it passes through the heating device before the heat source is brought into thermal contact with the set of fluid holding elements. This is also advantageous in providing an energy efficient fluid withdrawal system.

The heating device may suitably comprise at least one of a heat exchanger or a heat pump. This also renders the heating device energy efficient and allows the fluid extraction to take place in a desired way.

The at least one actuator A may comprise one or more such heating device. Thereby, the heating device may be controlled by the controller 205 in response to the second control signal C2. In some embodiments, the storage system on the vessel may comprise more than one fluid storage 115 unit which are connected by a manifold on top for receiving liquid from the bottom of pipes/conduits leading to the fluid storage 115 unit, and a manifold on top for receiving gas phase fluid from the top of the fluid storage 115 unit. The compressor 116 may be connected to one or several such pipes/conduits and increase the pressure of the gas phase fluid to reinject the heated and pressurized fluid into one or several such fluid storage 115 units.

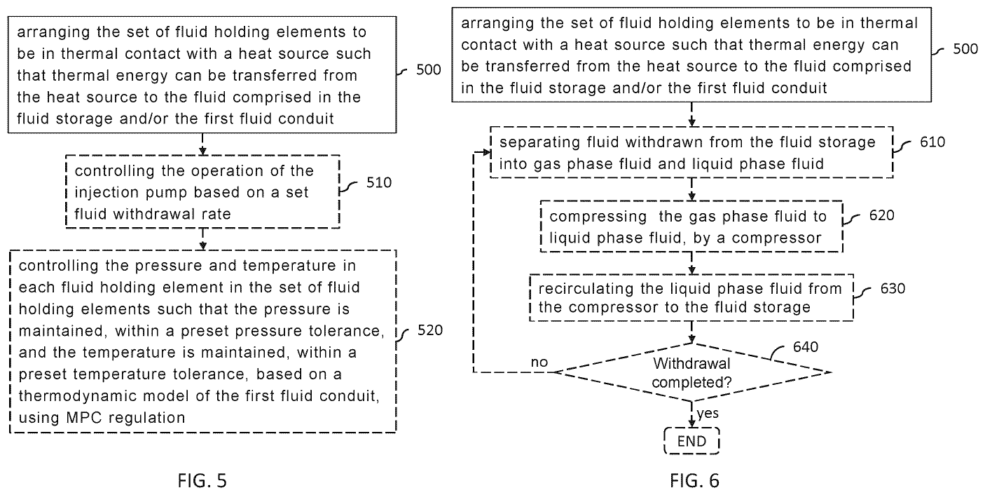

Embodiments of a method according to the invention will now be described in connection with FIGS. 5 and 6.

FIG. 5 is a flow diagram illustrating a method according to one embodiment of the invention for withdrawing, in a fluid withdrawal system 200, fluid to be injected into a long term subterranean reservoir 150 at an offshore injection site 100 from a fluid storage 115. FIG. 6 is a flow diagram illustrating additional method steps that may be included in the method in FIG. 4 according to one embodiment of the invention.

The fluid withdrawal system is the fluid withdrawal system 200 described in connection with FIGS. 1, 2, 3 and 4. As described herein, the fluid withdrawal system 200 comprises an injection pump 111 operatively connected to an outlet 115a of the fluid storage via a first fluid conduit 112 for withdrawing fluid from the fluid storage 115. The injection pump 111 is connectable to at least one injection riser 171, 172, such that fluid is enabled to flow from the injection pump 111 to the subterranean reservoir 150 when connected to the at least one injection riser 171, 172. The fluid withdrawal system 200 further comprises a set of fluid holding elements including at least one of the fluid storage 115 and the first fluid conduit 112. The set of fluid holding elements are configured to be in thermal contact with a heat source such that thermal energy can be transferred from the heat source to the fluid comprised in the fluid storage 115 and/or the first fluid conduit 112. Optionally, the set of fluid holding elements may in different embodiments further comprise at least one of the second fluid conduit 113, the first part 112a of the first fluid conduit 112 and the second part 112b of the first fluid conduit 112.

Turning first to the embodiments illustrated in FIG. 5, the method comprises:

In step 500: arranging the set of fluid holding elements to be in thermal contact with a heat source such that thermal energy can be transferred from the heat source to the fluid comprised in the fluid storage 115 and/or the first fluid conduit 112.

Thereby, the method enables control of the pressure and temperature in the set of fluid holding elements.

If the set of fluid holding elements comprises at least one of the second fluid conduit 113, the first part 112a of the first fluid conduit 112 and the second part 112b of the first fluid conduit 112 and/or more than one fluid storage 115, step 500 comprises arranging the set of fluid holding elements to be in thermal contact with a heat source such that thermal energy can be transferred from the heat source to the fluid comprised in any or all of: the at least one fluid storage 115; the first fluid conduit 112; the first part 112a of the first fluid conduit 112; the second part 112b of the first fluid conduit 112; and/or the second fluid conduit 113.

The heat source may comprise at least one of a first medium, M1, surrounding and being in thermal contact with the fluid storage 115 and/or the first fluid conduit 112 such that thermal energy can be transferred from the first medium, M1, to the fluid comprised in the fluid storage 115 and/or the first fluid conduit 112; or a second medium, M2, comprised in a conduit or container which is arranged in thermal contact with the fluid storage 115 and/or the first fluid conduit 112 such that thermal energy can be transferred from the second medium, M2, to the fluid comprised in the fluid storage 115 and/or the first fluid conduit 112. In these embodiments the controlling, by the controller 205, the pressure and temperature in each fluid holding element in the set of fluid holding elements comprises controlling the pressure and temperature using thermal heat transfer between the first medium M1 or the second medium M2 and the fluid. Thereby, thermal energy may be transferred to the fluid in a highly advantageous manner to maintain energy efficiency of the fluid withdrawal system 200.

In embodiments wherein the set of fluid holding elements comprises at least one of the second fluid conduit 113, the first part 112a of the first fluid conduit 112 and the second part 112b of the first fluid conduit 112 and/or comprises more than one fluid storage 115, the method may comprise transferring thermal energy also to these fluid holding units via the first and second mediums M1, M2 in the same manners as described above. The method may comprise transferring or conveying thermal energy via the first and second mediums M1, M2 in the form of heat from the ambient air, and/or waste heat from the engine of the vessel received via a conduit or other conveying device, and/or waste heat from the compressor 116 received via a conduit or other conveying device if the compressor 116 is comprised in the system 200. Thereby, control of pressure and temperature in the set of fluid holding elements is enabled.

Step 500 may further comprise generating, by the controller 205, a second control signal C2 for each fluid holding element in the set of fluid holding elements, based on a thermodynamic model of the fluid holding element, and using model predictive control, MPC, regulation. The second control signal is configured to cause at least one actuator A comprised in the system 200 to add energy in the form of heat to the respective fluid holding element in response to receiving the second control signal C2 associated with that fluid holding element. The at least one actuator A that is controlled by the controller 205 may as described in connection with FIG. 2 comprise any or all of exemplified heat supplying devices and substances/mediums described herein, including but not limited to the at least one heating device, any device or unit holding or conveying the first or second medium M1, M2, and/or any device (not shown in figures) conveying exhaust, waste, heat from the engine of the vessel and/or waste heat from the compressor 116. Thereby, improved control of the pressure and temperature in the set of fluid holding elements is enabled.

In an optional step 510: controlling, by a controller 205 comprised in the fluid withdrawal system 200, the operation of the injection pump 111 based on a set fluid withdrawal rate.

Step 510 may comprise generating, by the controller 205, a first control signal C1 based on a desired withdrawal rate and/or injection rate, the first control signal C1 being configured to cause the injection pump 111 to operate at an effect such that the desired withdrawal rate is met in response to receiving the first control signal C1. The withdrawal rate may indicate the desired time for emptying the fluid storage or the desired effect at which the pump is to operate. In some embodiments, the withdrawal rate may be determined based on the desired injection rate for injection into the subterranean void 150, or vice versa, as these are to some extent co-dependent variables.

In an optional step 520: controlling, by the controller 205 the pressure and temperature in each fluid holding element in the set of fluid holding elements such that the pressure is maintained, within a preset pressure tolerance, and the temperature is maintained, within a preset temperature tolerance, based on a thermodynamic model of the first fluid conduit 112, using model predictive control, MPC, regulation. Suitably, by controlling the pressure and temperature during withdrawal, the withdrawal of CO₂ is achieved in a highly energy efficient way while also taking significantly less time than in the known prior art systems. This decreases the transport cost for transporting and injecting CO₂ so that the process as a whole is rendered more efficient and convenient.

Turning now to FIG. 6, the method according to a second embodiment starts with step 500 as described in connection with FIG. 5 and may further continue in the optional method steps 610 to 640, comprising:

In step 610: separating the fluid that has been withdrawn from the fluid storage into gas phase fluid and liquid phase fluid.

Separating the fluid that has been withdrawn from the fluid storage into gas phase fluid and liquid phase fluid may be done by automatic methods such as compact gravity based separation, enabling leading gas phase fluid to the compressor 116 via the second part 112b of the first fluid conduit 112, hence allowing only (or substantially only) liquid phase fluid to reach the injection pump 111 via the first part 112a of the first fluid conduit 112. This is beneficial in allowing the separation of gas from liquid to be highly energy efficient while still preventing the mixing of the gas and liquid after the separation has taken place.

Alternatively, or additionally, the compressor 116 may be configured to separate the fluid that has been withdrawn from the fluid storage into gas phase fluid and liquid phase fluid by actively drawing or retrieving gas phase fluid to enter the second part 112b of the first fluid conduit 112, using any suitable known technique, hence allowing only (or substantially only) liquid phase fluid to reach the injection pump 111 via the first part 112a of the first fluid conduit 112. Using active retrieval of the gas phase liquid, alone or in combination with compact gravity based separation, is beneficial as it provides an increased control of the separation and may render higher separation efficiency compared to using only compact gravity based separation.

Step 610 may further comprise transporting the gas phase fluid via the second part 112b of the first fluid conduit 112 to the compressor 116 for compressing gas phase fluid to liquid phase fluid.

As described above for the separation step 610, the transportation in step 620 is enabled by automatic methods such as compact gravity based separation and/or actively drawing or retrieving gas phase fluid by the compressor 116.

In step 620: compressing the gas phase fluid to liquid phase fluid, by the compressor 116.

In step 630: recirculating the liquid phase fluid from the compressor 116 to an intake 115b of the fluid storage 115 via a second fluid conduit 113, such that part of the fluid flows in a loop from the fluid storage 115 to the compressor 116 and back to the fluid storage 115.

Thereby, fluid that is extracted from the fluid storage in gas phase can be returned to liquid phase by the compressor and be reintroduced into the fluid storage. This is also highly advantageous, since it allows for separating the liquid phase fluid for injection while at the same time recirculating the gas phase fluid to be extracted again at a later time. By allowing the extracted fluid to be both in the liquid phase and in the gas phase, a wider range for the pressure and temperature can be allowed, thus also rendering the withdrawal system more energy efficient. In order to further increase energy efficiency, heat generated by the compressor may be used to increase the temperature of the fluid withdrawal system as desired.

Also, in embodiments comprising the compressor 116, the set of fluid holding elements may further comprise at least one of the second fluid conduit 113, the first part 112a of the first fluid conduit 112 and the second part 112b of the first fluid conduit 112. Thereby, these parts of the conduits may also be included in the MPC regulation according to the present invention.

Steps 620 and 630 of compressing and recirculating the gas phase fluid may comprise generating, by the controller 205, a third control signal C3 configured to cause the compressor 116 to operate at an effect such that the gas phase fluid is compressed to liquid phase fluid and/or such that the compressor 116 recirculates compressed liquid phase fluid from the compressor 116 to the fluid storage 115 in response to receiving the third control signal C3. Thereby, fluid that is extracted from the fluid storage in gas phase can be returned to liquid phase by the compressor and be reintroduced into the fluid storage. This is also highly advantageous, since it allows for separating the liquid phase fluid for injection while at the same time recirculating the gas phase fluid to be extracted again at a later time. By allowing the extracted fluid to be both in the liquid phase and in the gas phase, a wider range for the pressure and temperature can be allowed, thus also rendering the withdrawal system more energy efficient.

In order to further increase energy efficiency, the method may comprise heating any or all fluid holding units using waste heat from the engine of the vessel and/or heat generated by the compressor to increase the temperature of the fluid withdrawal system as desired.

Optionally, the method may further comprise:

In step 640: Checking if the withdrawal of fluid is completed.

If the withdrawal is completed, the method ends. If the withdrawal is not completed, the method returns to step 610.

Any of the method embodiments described in connection with FIG. 5 that comprises controlling the operation of the pressure pump and/or controlling pressure and/temperature in fluid holding elements of the system 200, may be combined with any of the method embodiments described in connection with FIG. 6 that comprises using the compressor 116, unless it is specifically stated that this is unsuitable. Thereby, combined advantages are obtained which lead to rendering the withdrawal system even more energy efficient and/or enable even higher withdrawal rates without the risks involved according to known systems. Thereby, the cost for transporting and injecting CO₂ is even further decreased.

The method according to any embodiment described in connection with FIG. 5 or 6, or a combination thereof, may further comprise pre-heating the heat source before the heat source is brought into thermal contact with the set of fluid holding elements. This further increases energy efficiency during use of the fluid withdrawal system. In some embodiments, the heat source may be pre-heated by ambient air or by waste heat from e.g. engines that can be made available to heat the heat source, and/or by using a heating device 23. Pre-heating the heat source may comprise arranging it to be in thermal contact with ambient air or waste heat from e.g. the vessel engine(s) or the compressor 116. The heating device may suitably comprise at least one of a heat exchanger or a heat pump. This also renders the heating device energy efficient and allows the fluid extraction to take place in a desired way.

Withdrawing fluid according to any method embodiment described in connection with FIG. 6, comprising the compressor 116, may further comprise operating the fluid outlet 115a into the multiphase region. Thereby, the pressure in the fluid storage may be decreased even further while still maintaining the injection at a desired rate.

Variations to the disclosed embodiments can be understood and effected by those skilled in the art in practicing the claimed invention, from a study of the drawings, the disclosure, and the appended claims.

In one or more embodiment, there is provided a non-transitory computer-readable storage medium storing instructions which, when executed by processing circuitry 215 of the fluid withdrawal system 200, cause the system 200 to perform the method as defined in any of the method embodiments disclosed herein (in other words, in the claims, the summary, or the detailed description). The fluid withdrawal system 200 is the fluid withdrawal system 200 described in connection with FIGS. 1, 2, 3 and 4. The processing circuitry 215 may be comprised in the controller 205, as illustrated in FIG. 2.

The non-transitory computer-readable storage medium may store instructions which, when executed by the processing circuitry 215 of the fluid withdrawal system 200, cause the system 200 to separate the fluid that has been withdrawn from the fluid storage into gas phase fluid and liquid phase fluid; transport the gas phase fluid via the second part 112b of the first fluid conduit 112 to a compressor 116 for compressing gas phase fluid to liquid phase fluid; compress the gas phase fluid to liquid phase fluid, by the compressor 116; and recirculate the liquid phase fluid from the compressor 116 to an intake 115b of the fluid storage 115 via a second fluid conduit 113, such that part of the fluid flows in a loop from the fluid storage 115 to the compressor 116 and back to the fluid storage 115.

The non-transitory computer-readable storage medium may alternatively, or additionally, store instructions which, when executed by the processing circuitry 215 of the fluid withdrawal system 200, cause the system 200 to control, by a controller 205, the operation of the injection pump 111 based on a set fluid withdrawal rate; and control, by the controller 205 the pressure and temperature in each fluid holding element in the set of fluid holding elements such that the pressure is maintained, within a preset pressure tolerance, and the temperature is maintained, within a preset temperature tolerance, based on a thermodynamic model of the first fluid conduit 112, using model predictive control, MPC, regulation.

In one or more embodiments, the non-transitory computer-readable storage medium may further store instructions which, when executed by processing circuitry 215 of the system 200, cause the system 200 to perform the steps or functions according to any of the method embodiments described herein in connection with any of the FIG. 5 or 6.

The non-transitory computer-readable storage medium may for example be provided in a computer program product. In other words, a computer program product may for example comprise a non-transitory computer-readable storage medium storing instructions which, when executed by the processing circuitry 215 of the system 200, cause the system 200 to perform the method as defined in any of the method embodiments.

The storage medium may, but need not necessarily, be comprised in the system 200.

It will be appreciated that the processing circuitry (or a processor) may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide computer functionality, either alone or in conjunction with other computer components (such as a memory or storage medium).

It will also be appreciated that a memory or storage medium (or a computer-readable medium) may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by a processor or processing circuitry.

The term “comprises/comprising” when used in this specification is taken to specify the presence of stated features, integers, steps or components. The term does not preclude the presence or addition of one or more additional elements, features, integers, steps or components or groups thereof. The indefinite article “a” or “an” does not exclude a plurality. In the claims, the word “or” is not to be interpreted as an exclusive or (sometimes referred to as “XOR”). On the contrary, expressions such as “A or B” covers all the cases “A and not B”, “B and not A” and “A and B”, unless otherwise indicated. The mere fact that certain measures are recited in mutually different dependent claims does not indicate that a combination of these measures cannot be used to advantage. Any reference signs in the claims should not be construed as limiting the scope.

It is also to be noted that features from the various embodiments described herein may freely be combined, unless it is explicitly stated that such a combination would be unsuitable.

The invention is not restricted to the described embodiments in the figures, but may be varied freely within the scope of the claims.

1. A fluid withdrawal system in a fluid handling system for handling fluid to be injected into a subterranean reservoir at an offshore injection site for long term storage, the fluid withdrawal system comprising:
a fluid storage for storing fluid to be injected, the fluid storage comprising a fluid outlet;
an injection pump operatively connected to the fluid storage outlet via a first fluid conduit for withdrawing fluid from the fluid storage, wherein the injection pump is connectable to at least one injection riser, such that fluid is enabled to flow from the injection pump to the subterranean reservoir when connected to the at least one injection riser;
a set of fluid holding elements comprising at least one of the fluid storage and the first fluid conduit is configured to be in thermal contact with a heat source such that thermal energy can be transferred from the heat source to the fluid comprised in the fluid storage and/or the first fluid conduit;
a compressor for compressing gas phase fluid to liquid phase fluid, wherein the fluid storage further comprises a fluid storage intake, and wherein the compressor is operatively connected to the fluid storage intake via a second fluid conduit for recirculating liquid phase fluid from the compressor to the fluid storage, wherein the first fluid conduit diverges into a first part for transporting liquid phase fluid to the injection pump and a second part for transporting gas phase fluid, separated from the liquid phase fluid, to the compressor, such that part of the fluid flows in a loop from the fluid storage to the compressor and back to the fluid storage, wherein the first fluid conduit is configured to separate gas phase fluid from liquid phase fluid at the point where the first fluid conduit diverges into the first part and the second part by compact gravity based separation; and
a controller configured to control the pressure and temperature in each fluid holding element in the set of fluid holding elements such that the pressure is maintained, within a preset pressure tolerance, and the temperature is maintained, within a preset temperature tolerance, based on a thermodynamic model of the first fluid conduit, using model predictive control, MPC, regulation, wherein the controller is further configured to control the operation of the injection pump based on a set fluid withdrawal rate, wherein the heat source comprises at least one of:
a first medium, surrounding and being in thermal contact with the fluid storage and/or the first fluid conduit such that thermal energy can be transferred from the first medium, to the fluid comprised in the fluid storage and/or the first fluid conduit; and
a second medium, comprised in a conduit or container which is arranged in thermal contact with the fluid storage and/or the first fluid conduit such that thermal energy can be transferred from the second medium, to the fluid comprised in the fluid storage and/or the first fluid conduit, and
wherein the system is configured to transfer thermal energy, via the first and second mediums, in the form of heat from the ambient air, waste heat from the engine of the vessel received via a conduit or other conveying device, or waste heat from the compressor received via a conduit or other conveying device if the compressor is comprised in the system.

2. The system of claim 1, wherein the set of fluid holding elements further comprises at least one of the second fluid conduit, the first part of the first fluid conduit and the second part of the first fluid conduit.

3. The system of claim 1, wherein the fluid outlet is configured to be operable into the multiphase region and the first fluid conduit is configured to transport multiphase fluid from the fluid storage.

4. The system of claim 1, wherein the heat source is pre-heated.

5. The system of claim 1, further comprising a heating device configured to increase a temperature of the heat source as it passes through the heating device before the heat source is brought into thermal contact with the set of fluid holding elements.

6. The system of claim 5, wherein the heating device comprises at least one of a heat exchanger and a heat pump.

7. A method for withdrawing, in a fluid withdrawal system, fluid to be injected into a subterranean reservoir at an offshore injection site from a fluid storage for long term storage, the fluid withdrawal system comprising an injection pump operatively connected to an outlet of the fluid storage via a first fluid conduit for withdrawing fluid from the fluid storage, wherein the first fluid conduit diverges into a first part for transporting liquid fluid to the injection pump and a second part for transporting gas phase fluid, wherein the injection pump is connectable to at least one injection riser, such that fluid is enabled to flow from the injection pump to the subterranean reservoir when connected to the at least one injection riser, the fluid withdrawal system further comprising a set of fluid holding elements including at least one of the fluid storage and the first fluid conduit, wherein the set of fluid holding elements further comprises at least one of the second fluid conduit, the first part of the first fluid conduit and the second part of the first fluid conduit, the method comprising:
arranging the set of fluid holding elements to be in thermal contact with a heat source such that thermal energy can be transferred from the heat source to the fluid comprised in the fluid storage and/or the first fluid conduit;
separating the fluid that has been withdrawn from the fluid storage into gas phase fluid and liquid phase fluid;
transporting the gas phase fluid via the second part of the first fluid conduit to a compressor for compressing gas phase fluid to liquid phase fluid;
compressing the gas phase fluid to liquid phase fluid, by the compressor;
recirculating the liquid phase fluid from the compressor to an intake of the fluid storage via a second fluid conduit, such that part of the fluid flows in a loop from the fluid storage to the compressor and back to the fluid storage, wherein separating the fluid that has been withdrawn from the fluid storage into gas phase fluid and liquid phase fluid is done by compact gravity based separation;
controlling, by a controller the pressure and temperature in each fluid holding element in the set of fluid holding elements such that the pressure is maintained, within a preset pressure tolerance, and the temperature is maintained, within a preset temperature tolerance, based on a thermodynamic model of the first fluid conduit, using model predictive control, MPC, regulation;
controlling, by the controller comprised in the fluid withdrawal system, the operation of the injection pump based on a set fluid withdrawal rate;
operating the fluid outlet into the multiphase region, wherein the heat source comprises at least one of a first medium, surrounding and being in thermal contact with the fluid storage and/or the first fluid conduit such that thermal energy can be transferred from the first medium, to the fluid comprised in the fluid storage and/or the first fluid conduit; or a second medium, comprised in a conduit or container which is arranged in thermal contact with the fluid storage and/or the first fluid conduit such that thermal energy can be transferred from the second medium, to the fluid comprised in the fluid storage and/or the first fluid conduit; and wherein controlling, by the controller, the pressure and temperature in each fluid holding element in the set of fluid holding elements comprises controlling the pressure and temperature using thermal heat transfer to or from the first medium or the second medium; and
transferring or conveying thermal energy via the first and second mediums in the form of heat from the ambient air, and/or waste heat from the engine of the vessel received via a conduit or other conveying device, and/or waste heat from the compressor received via a conduit or other conveying device if the compressor is comprised in the system.

8. The method of claim 7, further comprising pre-heating the heat source.

9. The method of claim 7, further comprising increasing the temperature of the heat source using a heating device before the heat source is brought into thermal contact with the set of fluid holding elements.

10. A non-transitory computer-readable storage medium storing instructions which, when executed by processing circuitry of the fluid withdrawal system of claim 1, cause the system to:
separate the fluid that has been withdrawn from the fluid storage into gas phase fluid and liquid phase fluid;
transport the gas phase fluid via the second part of the first fluid conduit to a compressor for compressing gas phase fluid to liquid phase fluid;
compress the gas phase fluid to liquid phase fluid, by the compressor;
recirculate the liquid phase fluid from the compressor to an intake of the fluid storage via a second fluid conduit, such that part of the fluid flows in a loop from the fluid storage to the compressor and back to the fluid storage, wherein separating the fluid that has been withdrawn from the fluid storage into gas phase fluid and liquid phase fluid is done by compact gravity based separation;
control, by a controller the pressure and temperature in each fluid holding element in the set of fluid holding elements such that the pressure is maintained, within a preset pressure tolerance, and the temperature is maintained, within a preset temperature tolerance, based on a thermodynamic model of the first fluid conduit, using model predictive control, MPC, regulation;
control, by the controller comprised in the fluid withdrawal system, the operation of the injection pump based on a set fluid withdrawal rate;
operate the fluid outlet into the multiphase region, wherein the heat source comprises at least one of a first medium, surrounding and being in thermal contact with the fluid storage and/or the first fluid conduit such that thermal energy can be transferred from the first medium, to the fluid comprised in the fluid storage and/or the first fluid conduit; or a second medium, comprised in a conduit or container which is arranged in thermal contact with the fluid storage and/or the first fluid conduit such that thermal energy can be transferred from the second medium, to the fluid comprised in the fluid storage and/or the first fluid conduit; and wherein controlling, by the controller, the pressure and temperature in each fluid holding element in the set of fluid holding elements comprises controlling the pressure and temperature using thermal heat transfer to or from the first medium or the second medium; and
transfer or convey thermal energy via the first and second mediums in the form of heat from the ambient air, and/or waste heat from the engine of the vessel received via a conduit or other conveying device, and/or waste heat from the compressor received via a conduit or other conveying device if the compressor is comprised in the system.
